(19) United States
(12) Patent Application Publication
(10) Pub. No.: US 2024/0425277 A1
(43) Pub. Date: Dec. 26, 2024

(54) STORAGE SYSTEM

(71) Applicant: Autostore Technology AS, Nedre Vats (NO)

(72) Inventors: Ragnar Stuhaug, Skjold (NO); Trond Austrheim, Etne (NO)

(73) Assignee: Autostore Technology AS, Nedre Vats (NO)

(21) Appl. No.: 18/706,677

(22) PCT Filed: Jul. 29, 2022
(86) PCT No.: PCT/EP2022/071443

§ 371 Date: May 1, 2024

(30) Foreign Application Priority Data
Nov. 1, 2021 (NO) 20211317

(51) Int. Cl. B65G 1/04; B65G 57/02; B66C 1/66; B66C 17/00; B66F 9/06

(52) U.S. Cl. CPC B65G 1/0464; B65G 1/0478; B65G 1/0492; B65G 57/02; B66C 1/663; B66C 17/00; B66F 9/063; B65G 2201/0235

(57) ABSTRACT

A storage system includes a framework structure, at least one container lift device, and a plurality of storage containers. The framework structure includes multiple storage columns, in which the storage containers are stored on top of one another in vertical stacks. The container lift device includes a lifting frame for releasable connection to one of the storage containers when the lifting frame is lowered into one of the storage columns to retrieve said storage container. An outer periphery of each storage container includes a vertical guiding pin recess at each of four container corners. A vertical guiding pin is provided at each of four frame corners of the lifting frame. A lower part of at least two of the guiding pins have a container support portion including a container support surface.

### FIELD OF THE INVENTION

The present invention relates to a storage system and a container lift device for retrieving storage containers from the storage system.

### BACKGROUND AND PRIOR ART

FIG. 1 discloses a prior art automated storage and retrieval system 1 with a framework structure 100 and FIGS. 2, 3 and 4 disclose three different prior art container handling vehicles 201, 301, 401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminium profiles.

The framework structure 100 of the automated storage and retrieval system 1 comprises a rail system 108 (i.e. a rail grid) arranged across the top of framework structure 100, on which rail system 108 a plurality of container handling vehicles 201, 301, 401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201, 301, 401 in a first direction X across the top of the frame structure 100, and a second set of parallel rails 111 arranged perpendicular to the first set of rails 110 to guide movement of the container handling vehicles 201, 301, 401 in a second direction Y which is perpendicular to the first direction X. Containers 106 stored in the columns 105 are accessed by the container handling vehicles 201, 301, 401 through access openings 112 in the rail system 108. The container handling vehicles 201, 301, 401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supportive.

Each prior art container handling vehicle 201, 301, 401 comprises a vehicle body 201a, 301a, 401a and first and second sets of wheels 201b, 201c, 301b, 301c, 401b, 401c which enable the lateral movement of the container handling vehicles 201, 301, 401 in the X direction and in the Y direction, respectively. In FIGS. 2, 3 and 4 two wheels in each set are fully visible. The first set of wheels 201b, 301b, 401b is arranged to engage with two adjacent rails of the first set 110 of rails, and the second set of wheels 201c, 301c, 401c is arranged to engage with two adjacent rails of the second set 111 of rails. At least one of the sets of wheels 201b, 301b, 201c, 301c, 401b, 401c can be lifted and lowered, so that the first set of wheels 201b, 301b, 401b and/or the second set of wheels 201c, 301c, 401c can be engaged with the respective set of rails 110, 111 at any one time.

Each prior art container handling vehicle 201, 301, 401 also comprises a lift device 404, see FIG. 4, for vertical transportation of storage containers 106 (i.e. a container lift device), e.g. raising a storage container 106 from, and lowering a storage container 106 into, a storage column 105. The lift device 404 features a lifting frame 2 comprising container connectors 3, adapted to engage connecting recesses 13 at an upper rim of the sidewalls 14 of a storage container 106, see FIG. 5, and guiding pins 4. The guiding pins 4 are arranged to interact with guiding pin recesses 7 at the corners of the storage container and ensure a correct alignment of the lifting frame 2 and container connectors 3 relative to the storage container. The guiding pins 4 will also assist in guiding the lifting frame 2 relative to the upright members of the storage column 105. The lifting frame 2 can be lowered from the vehicle 201, 301, 401 so that the position of the lifting frame 2 with respect to the vehicle 201, 301, 401 can be adjusted in a third direction Z which is orthogonal the first direction X and the second direction Y. The lifting device of the container handling vehicle 201 is located within the vehicle body 201a in FIG. 2.

To raise or lower the lifting frame 2 (and optionally a connected storage container 106), the lifting frame 2 is suspended from a band drive assembly by lifting bands 5. In the band drive assembly, the lifting bands are commonly spooled on/off at least one rotating lifting shaft or reel arranged in the container handling vehicle. Various designs of band drive assemblies are described in for instance WO 2015/193278 A1, WO 2017/129384 A1 and WO 2019/206438 A1.

Conventionally, and also for the purpose of this application, Z=1 identifies the uppermost layer for storing storage containers below the rail system 108, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201, 301, 401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201, 301, 401 comprises a storage compartment or space for receiving and stowing a storage container 106 when transporting the storage container 106 across the rail system 108. The storage space may comprise a cavity arranged internally within the vehicle body 201a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicles 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail may comprise two parallel tracks.

WO2018/146304A1, the contents of which are incorporated herein by reference, illustrates a typical configuration of rail system 108 comprising rails and parallel tracks in both X and Y directions forming a rail grid.

In the framework structure 100, most of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201, 301, 401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119, 120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119, 120 for further transportation to an access station. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201, 301, 401 can drop off storage containers 106 to be transported to an access or a transfer station, and the second port column 120 may be a dedicated pick-up port column where the container handling vehicles 201, 301, 401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1 but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119, 120 and the access station.

If the port columns 119, 120 and the access station are located at different levels, the conveyor system may comprise a lift device with a vertical component for transporting the storage containers 106 vertically between the port column 119, 120 and the access station.

The conveyor system may be arranged to transfer storage containers 106 between different framework structures, e.g. as is described in WO2014/075937A1, the contents of which are incorporated herein by reference.

When a storage container 106 stored in one of the storage columns 105 disclosed in FIG. 1 is to be accessed, one of the container handling vehicles 201, 301, 401 is instructed to retrieve the target storage container 106 from its position and transport it to the drop-off port column 119. This operation involves moving the container handling vehicle 201, 301, 401 to a location above the storage column 105 in which the target storage container 106 is positioned, retrieving the storage container 106 from the storage column 105 using the container handling vehicle's 201, 301, 401 lifting device 404, and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201, 301, 401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201, 301, 401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201, 301, 401 positions the storage container 106 at the desired position. The removed storage containers 106 may then be lowered back into the storage column 105 or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201, 301, 401 so that a desired storage container 106 can be delivered to the desired location at the desired time without the container handling vehicles 201, 301, 401 colliding with each other, the automated storage and retrieval system 1 comprises a control system 500 which typically is computerized and which typically comprises a database for keeping track of the storage containers 106.

During use of prior art storage systems as described above, the lift device 404 may in some instances be unable to properly lock onto a storage container 106 to be retrieved from a storage column 105. This issue is often caused by excessive or improper loading of items into the storage container. Excessive or improper loading may for instance cause the sidewalls 14 of the storage container 106 to bulge out such that the container connectors 3 are unable to align with the connecting recesses 13 of the storage container, or cause parts of a loaded item to extend out of the storage container. The latter may block one or more of the connecting recesses 13 of the storage container or prevent proper landing of the lifting frame on top of the storage container.

An object of the present invention is to provide a lifting device that alleviates problems related to retrieval of improperly loaded storage containers.

### SUMMARY OF THE INVENTION

The present invention is defined by the attached claims and in the following:

In a first aspect, the present invention provides a storage system comprising a framework structure, at least one container lift device and a plurality of storage containers, the framework structure comprises multiple storage columns, in which the storage containers are stored on top of one another in vertical stacks, and the container lift device comprises a lifting frame for releasable connection to one of the storage containers when the lifting frame is lowered into one of the storage columns to retrieve said storage container, wherein
an outer periphery of each storage container comprises a vertical guiding pin recess at each of four container corners, and
a vertical guiding pin is provided at each of four frame corners of the lifting frame, a lower part of at least two of the guiding pins have a container support portion comprising a container support surface,
wherein the container support portion is moveable in a lateral direction between a first position, in which the guiding pins can enter the corresponding guiding pin recess of a storage container, and a second position, in which the container support portion is displaced closer to a vertical centreline of the lifting frame than in the first position such that the container support surfaces are positioned to support the storage container via downwardly facing support surfaces of the storage container.

The lifting frame may be suspended by a set of lifting bands allowing the lifting frame to be raised and lowered in a vertical direction.

The lifting frame may be suspended by the lifting bands from a band drive assembly comprising at least one rotatable lifting shaft or reel, such that the lifting frame is raised when the lifting bands are spooled onto the at least one lifting shaft/reel and lowered when the lifting bands are spooled off the at least one lifting shaft/reel. The band drive assembly may be connected to a mobile vehicle or gantry such that the lifting frame and any releasably connected storage container may be transported in a horizontal direction relative to the framework structure. In other words, the container lift device may comprise or be part of a mobile vehicle or gantry such that the lifting frame and any releasably connected storage container may be transported in a horizontal direction relative to the framework structure

The releasable connection of the lifting frame to a storage container allows the container lift device to lift the storage container from a storage column or lower the storage column into a storage column.

When the lifting frame is lowered into one of the storage columns to retrieve a storage container, the storage container to be retrieved is the uppermost storage container in a stack of containers.

The lower part of each guiding pin may be arranged at a level below a lower bottom surface of the lifting frame

The container support surface may be termed an upwardly facing support surface. The container support surface faces upwardly at least when the container support portion is in the second position.

In the second position, the container support portions of two opposite guiding pins may be closer than in the second position.

In the second position, each container support portion may extend further inwards from an outer periphery of the lifting frame than in the first position.

In the second position, each container support portion may be closer to a centerpoint or vertical centreline of the lifting frame than in the first position.

In the second position, the container support surfaces may face in an upwardly direction and may be positioned to support the storage container via downwardly facing support surfaces of the storage container. In other words, at least in the second position the container support surfaces comprise upwardly facing support surface, i.e. container support surfaces, positioned under the downwardly facing support surface of the storage container.

In the first position, the container support portions may not extend within an outer periphery of a storage container, the outer periphery at the level of the guiding pin recesses, when the lifting frame is arranged on top of the storage container.

In the first position, the guiding pins may enter the corresponding guiding pin recess of a storage container in a vertical direction, i.e. the guiding pins may enter the corresponding guiding pin recess when moved in a downwards vertical direction towards the storage container.

In the first position, the guiding pins may interact with the guiding pin recesses at the corners of the storage container during lowering of the lifting frame onto the storage container to ensure a correct alignment of the lifting frame relative to the storage container.

The at least two guiding pins having a lower part featuring a container support portion may be arranged on diagonally opposite sides of the lifting frame, e.g. on diagonally opposite sides of the vertical centreline of the lifting frame.

In an embodiment of the storage system, the guiding pins may be arranged to guide the lifting frame relative to upright members defining the storage columns. The guiding pins may perform a plurality of functions, that is guiding the lifting frame relative to the upright members defining the storage columns, guiding the lifting frame relative to a storage container to ensure correct alignment and releasably connect the lifting frame to a storage container.

In an embodiment of the storage system, each of the guiding pins may feature a container support portion.

In an embodiment of the storage system, each of the downwardly facing support surfaces of the storage container is arranged on a corresponding horizontal rib portion at the periphery of the guiding pin recesses. When the downwardly facing support surface is arranged on a rib, the upwardly facing support surface may be positioned under the rib when in the second position.

In an embodiment of the storage system, each of the container support portions is configured to extend under the corresponding horizontal rib portion of a storage container when the container support portions are in the second position and the guiding pins are arranged in the guiding pin recesses of the storage container.

Each of the container support portions, and the corresponding container support surface, may be configured to extend under the corresponding horizontal rib portion of a storage container when in the second position.

In an embodiment of the storage system, each of the container support portions is removed from the corresponding horizontal rib portion when in the first position, such that the storage container is released from the lifting frame. In other words, each of the container support surfaces is laterally removed from the corresponding horizontal rib portion when the corresponding container support portion is in the first position. In an embodiment of the storage system, the lifting frame may comprise a lower bottom surface, and the container support surfaces are arranged at a level below the lower bottom surface such that a horizontally extending gap is formed between the lower bottom surface and an upper rim of a storage container to which the lifting frame is connected, the height of the gap may be 0.5 cm or more, 1.0 cm or more and preferably between 0.5 and 20.5 cm.

In an embodiment of the storage system, the container support portions extend to a level below the bottom surface, such that a first vertical distance between the container support surfaces, i.e. upwardly facing support surfaces, and the bottom surface of the lifting frame is greater than a second vertical distance between the downwardly facing support surfaces of the storage container and an upper rim of the storage container, such that the gap is obtained.

In an embodiment of the storage system, the lifting frame may comprise an actuator assembly for moving the container support portions between the first position and the second position, the actuator assembly comprising an electric motor or linear actuator.

In an embodiment of the storage system, the container support portions may be biased, e.g. by a spring, magnets and/or pneumatic/hydraulic actuators, for example towards the second position.

In an embodiment of the storage system, the container support portion may comprise a recess in the guiding pin, and a lower part of the recess provides the upwardly facing support surface. The recess may be shaped as a notch.

In an embodiment of the storage system, the recess may have a height of more than a vertical distance between the downwardly facing support surfaces of the storage container and an upper rim of the storage container.

In an embodiment of the storage system, the container support portions are moveable from the first position to the second position by moving the guiding pins closer to the vertical centreline of the lifting frame.

In an embodiment of the storage system, the guiding pins are slidably arranged on the lifting frame, such that the guiding pins are moveable in a horizontal direction relative to the vertical centreline of the lifting frame. The guiding pins may have a fixed vertical orientation while moved in the horizontal direction. In other words, the vertical orientation of the guiding pins is the same in the first position and the second position.

In an embodiment of the storage system, each of the guiding pins may have a tapered lower end, such that correct insertion of the guiding pins in the corresponding guiding pin recess is facilitated. In other words, the tapered end helps to guide the guiding pins into the guiding pin recesses.

In an embodiment of the storage system, each of the guiding pins may have an upper end extending above the level of a top surface of the lifting frame. Having the upper ends extending above the top surface provides improved guidance of the lifting frame when moving vertically inside a storage column and minimizes potential horizontal misalignment of the lifting frame.

In an embodiment of the storage system, the container support portion may comprise a hook, the hook comprising the container support surface and is configured to pivot between the first position and the second position. That is configured such that the container support surface faces upwardly and is positioned below the downwardly facing support surfaces when in the second position. The hook may be configured to pivot around a horizontal axis, i.e. an axis being perpendicular to a centre axis of the vertical guide pins.

In an embodiment, the storage system may comprise a rail system arranged at a top level of the framework structure, and the container lift device is part of a first type of container handling vehicle operated on the rail system for retrieving storage containers from, and storing storage containers in, the storage columns, and for transporting the storage containers horizontally across the rail system. In other words, the storage system features a first type of container handling vehicle comprising the container lift device.

In an embodiment, the storage system may comprise a plurality of a second type of container handling vehicles operated on the rail system for retrieving storage containers from, and storing storage containers in, the storage columns, and for transporting the storage containers horizontally across the rail system, each of the second type of container handling vehicles featuring a container lift device comprising a lifting frame for releasable connection to one of the storage containers when the lifting frame is lowered into one of the storage columns to retrieve said storage container, wherein
the lifting frame comprises a vertical guiding pin at each of four frame corners of the lifting frame and a plurality of container connectors for engagement with corresponding connecting recesses at an upper rim of the storage container.

The container connectors of the container lift device of the second type of container handling vehicle are separate from the vertical guiding pins. The container connectors may be arranged at a bottom side or surface of the lifting frame. The connecting recesses may be holes through the upper rim of the storage container, i.e. holes through a horizontal surface of the upper rim. The second type of container handling vehicle and the corresponding container lift device may be similar or identical to the prior art container handling vehicles and the container lift device disclosed in the background section above. Each of the storage containers in the storage system may comprise the connecting recesses at an upper rim of the storage container. The connecting recesses may be the interface for releasable connection to a lifting frame of the second type of container handling vehicle, while the guiding pin recesses function as the interface for releasable connection to a lifting frame of the first type of container handling vehicle.

The guiding pins of the lifting frame of the second type of container handling vehicle do not feature container support portions. All parts or portions of the guiding pins of the lifting frame of the second type of container handling vehicle are in a fixed position relative to the remaining parts of the lifting frame. The guiding pins of the lifting frame of the second type of container handling vehicle may also be termed a second type of guiding pins.

In an embodiment of the storage system, the framework structure may comprise vertical column profiles, or upright members, defining the storage columns, each of the storage columns is defined by four of the vertical column profiles, and each of the column profiles comprises four corner sections, wherein each corner section is arranged to accommodate a corner of a storage container. The inner periphery of each storage column may be defined by a rectangle delimited by the inner periphery of the corner sections of the four column profiles defining the storage column. Each of the guiding pins of the lifting frame, independent of whether the guiding pin features a container support portion, may interact with a corresponding corner section, or upright member, to guide the movement of the lifting frame inside the storage column.

In a second aspect, the present invention provides a lifting frame, or a container lift device comprising a lifting frame, for a storage system according to any embodiment of the first aspect, wherein a vertical guiding pin is connected at each of four frame corners of the lifting frame and at least two of the vertical guiding pins are slidably connected at a corresponding frame corner, a lower part of each of the slidably connected guiding pins having a container support portion comprising a container support surface,
wherein the container support portion is moveable between a first position and a second position by sliding the corresponding guiding pin in a horizontal direction, in the second position the container support portion and the corresponding guiding pin are displaced closer to a vertical centreline of the lifting frame than in the first position.

In an embodiment of the lifting frame, four of the vertical guiding pins are slidably connected at a corresponding frame corner.

In an embodiment of the lifting frame, each of the guiding pins may be slidably connected at a corresponding frame corner by a bracket, the brackets of two opposite guiding pins being interconnected by an actuator assembly arranged to laterally move the brackets toward each other, such that the container support portions of the two opposing guiding pins will move toward each other from the first position to the second position. Two opposite or opposing guiding pins are arranged at opposite ends of a common side of the lifting frame.

The actuator assembly may be a pivot assembly. The pivot assembly may comprise two actuator arms, each arm connected to an actuatable pivot and a corresponding bracket, such that rotation of the pivot translates into lateral movement of the brackets in opposite directions.

In an embodiment of the lifting frame, the guiding pins may have a fixed vertical orientation while moved in the horizontal direction. In other words, the vertical orientation of the guiding pins is the same in the first position and the second position.

In a third aspect, the present invention provides a container handling vehicle for a storage system according to the first aspect, the container handling vehicle comprises a container lift device having a lifting frame for releasable connection to a storage container, a vehicle body and a first set of wheels and a second set of wheels enabling horizontal movement of the container handling vehicle in two perpendicular directions upon a rail system, wherein
a vertical guiding pin is provided at each of four frame corners of the lifting frame, a lower part of at least two of the guiding pins have a container support portion comprising a container support surface, and
the container support portion is moveable in a horizontal direction between a first position and a second position, in the second position the container support portion is displaced closer to a vertical centreline of the lifting frame than in the first position.

The container handling vehicle may comprise any of the features related to the container lift device defined in the first aspect and the second aspect of the invention.

In a fourth aspect, the present invention provides a method of retrieving a storage container from a storage column in a storage system according to the first aspect comprising a first type of container handling vehicle and a second type of container handling vehicle as defined above, the method comprising the steps of:
moving the second type of container handling vehicle to retrieve the storage container from the storage column;
lowering the lifting frame of the second type of container handling vehicle into the storage column to retrieve the storage container;
detecting an error in the connection of the lifting frame to the storage container;
raising the lifting frame and moving the second type of container handling vehicle away from the storage column;
moving the first type of container handling vehicle to the storage column; and
lowering the lifting frame of the first type of container handling vehicle into the storage column and retrieving the storage container.

In a fifth aspect, the present invention provides a method of retrieving a storage container from a storage column in a storage system according to the first aspect, the method comprising the steps of:
moving the container lift device to retrieve the storage container from the storage column;
lowering the lifting frame into the storage column to retrieve the storage container;
introducing the guiding pins into the respective guiding pin recesses of the storage container while the container support portions are in the first position;
moving the container support portions to the second position to releasably connect to the storage container; and
raising the lifting frame out of the storage column to retrieve the storage container.

In an embodiment of the method according to the fifth aspect, a horizontally extending gap is present between a lower bottom surface of the lifting frame and an upper rim of the storage container during the step of moving the container support portions to the second position. In this manner, a releasable connection between the lifting frame and the storage container may be obtained even if goods stored in the storage container extends above the opening of the storage container.

In an embodiment, the method according to the fourth or fifth aspect may comprise a further step of moving the retrieved storage container to a service station. At the service station, the retrieved container may be restocked, checked for damage and similar.

### BRIEF DESCRIPTION OF THE DRAWINGS

Embodiments of the invention is described in detail by reference to the following drawings:

FIG. 1 is a perspective view of a framework structure of a prior art automated storage and retrieval system.

FIG. 2 is a perspective view of a prior art container handling vehicle having a centrally arranged cavity for carrying storage containers therein.

FIG. 3 is a perspective view of a prior art container handling vehicle having a cantilevered section for carrying storage containers underneath.

FIG. 4 is a perspective view of a prior art container handling vehicle, wherein a container lifting assembly is shown.

FIG. 5 is a perspective view of a storage container as used in the storage system in FIG. 1.

FIGS. 6-14 show a first exemplary embodiment of the invention.

FIGS. 15-18 show a second exemplary embodiment of the invention.

### DETAILED DESCRIPTION OF THE INVENTION

In the following, embodiments of the invention will be discussed in more detail with reference to the appended drawings. The drawings are not intended to limit the invention to the illustrated subject-matter.

As discussed above, the prior art container lift device 404 may in some instances be unable to properly lock onto a storage container 106 to be retrieved from a storage column 105. This issue is often caused by excessive or improper loading of items into the storage container. Excessive or improper loading may for instance cause the sidewalls 14 of the storage container 106 to bulge out such that the container connectors 3 (or gripper elements) are unable to align with the connecting recesses 13 arranged in the upper rim 16 of the storage container. Improper loading of e.g. compressed clothing may also cause parts of the clothing to extend out of the storage container. The latter may block one of the connecting recesses 13 of the storage container or prevent landing of the lifting frame on top of the storage container.

The exemplary embodiments discussed below provide container lift devices that avoids or at least alleviate problems related to retrieval of improperly loaded storage containers.

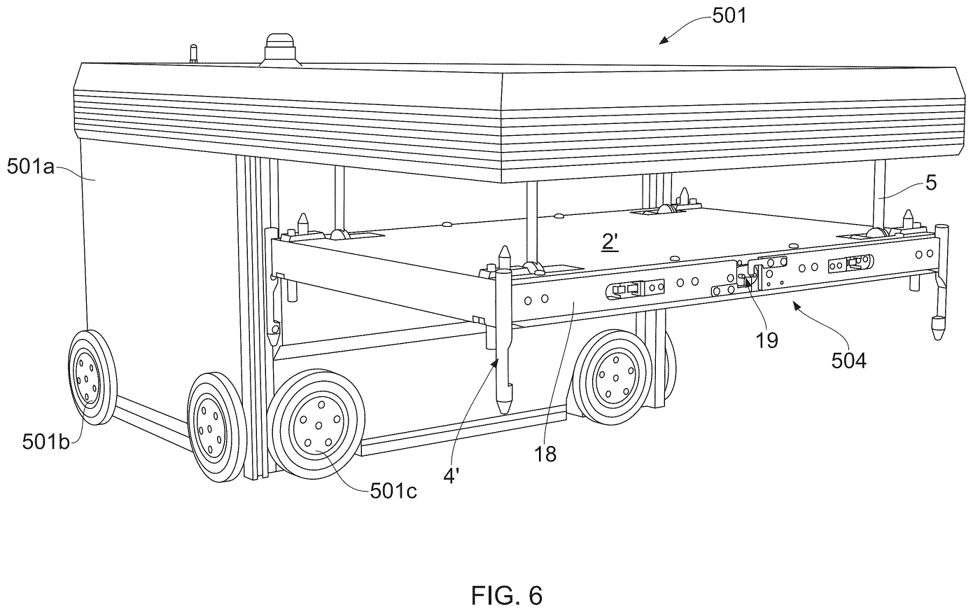

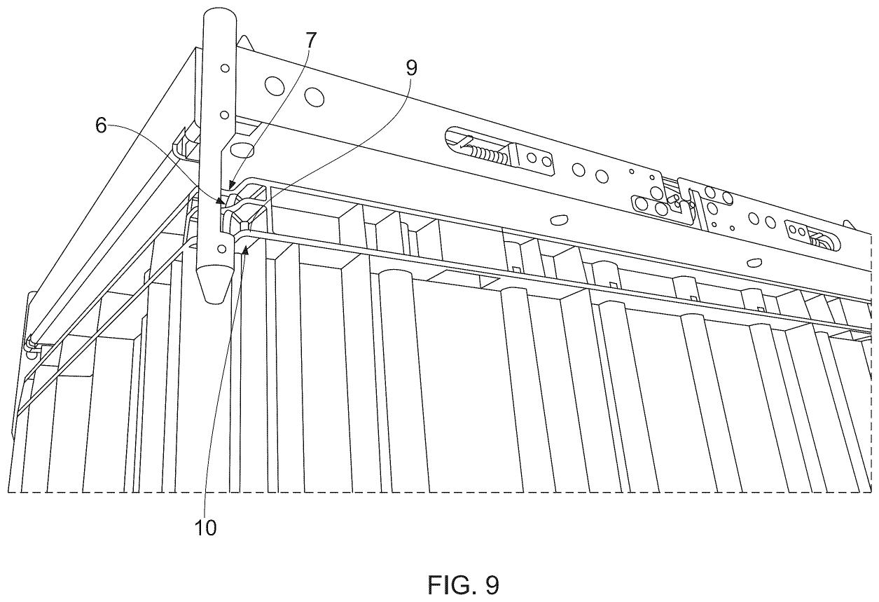

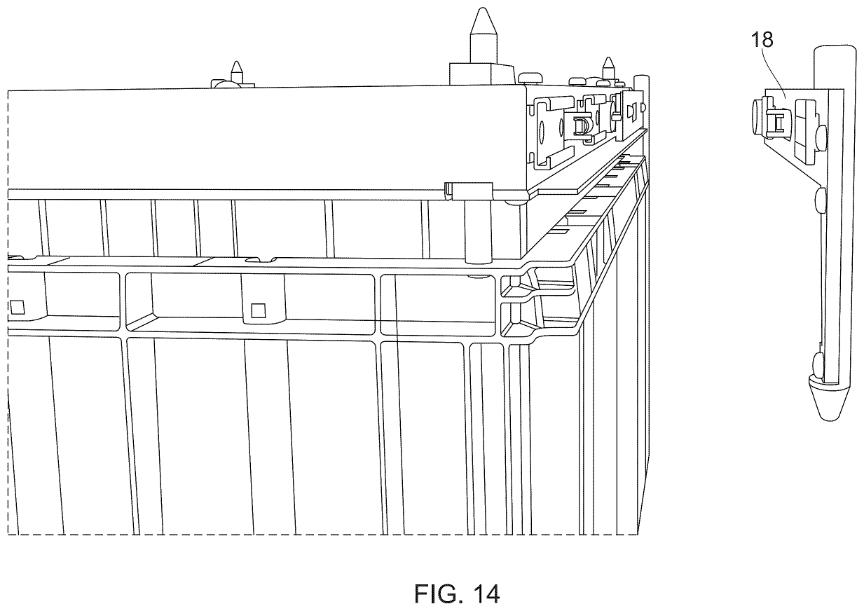

A first exemplary embodiment of the invention is shown in FIGS. 6-14.

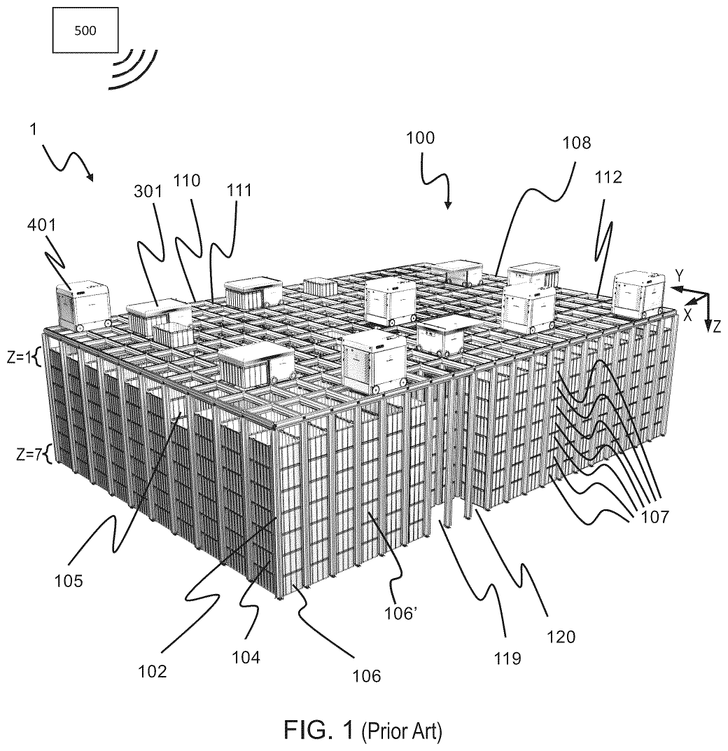

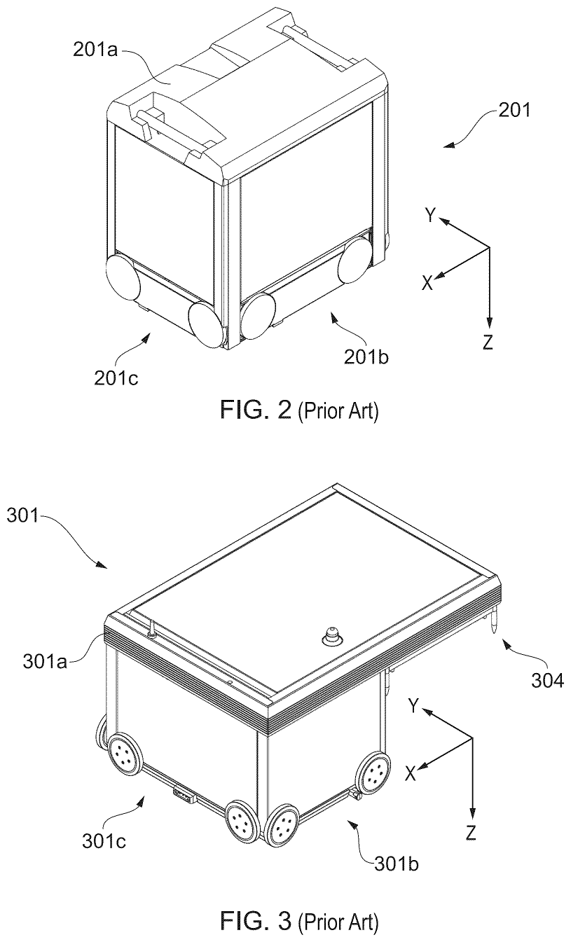

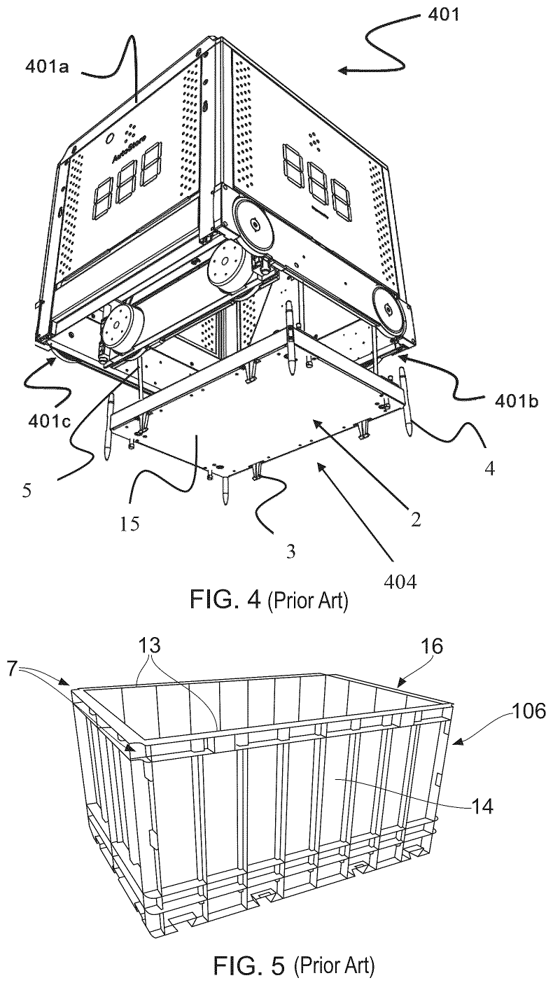

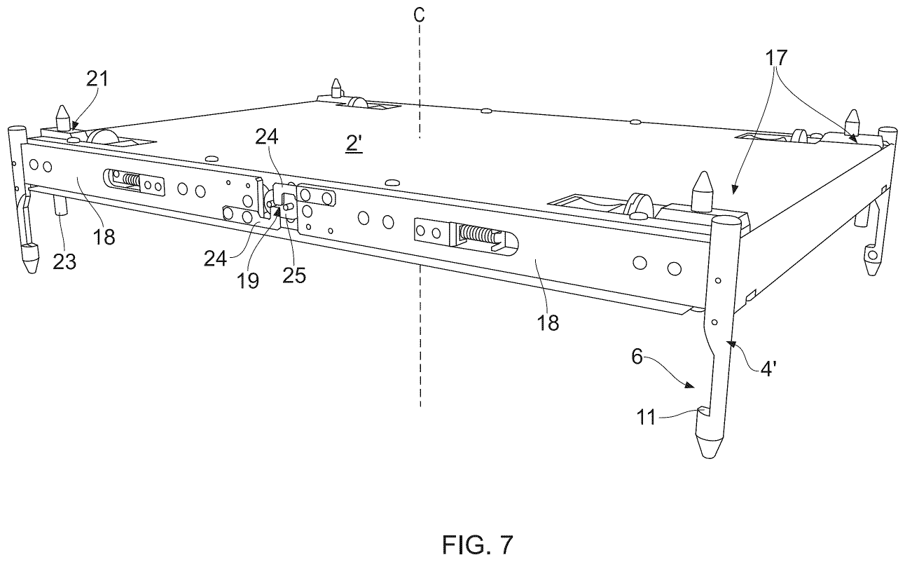

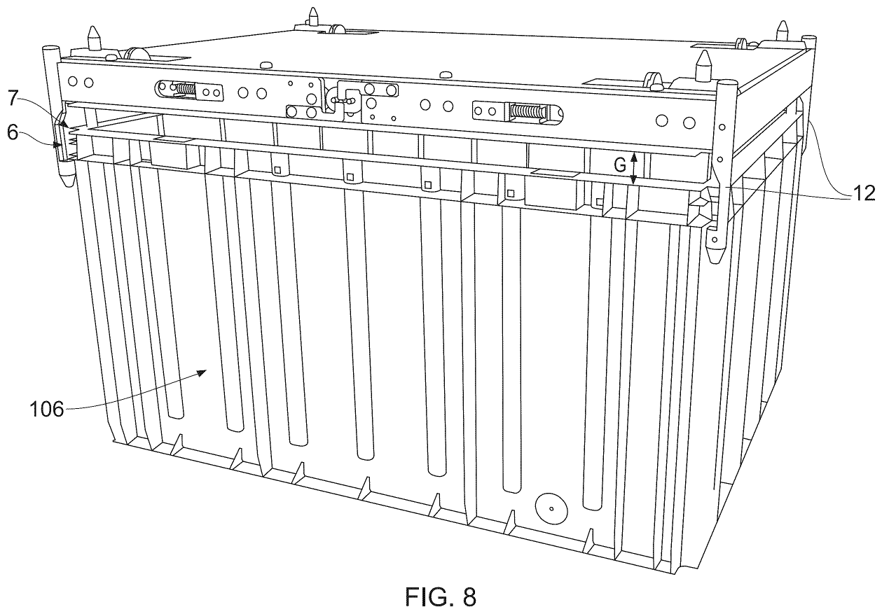

FIG. 6 shows a container handling vehicle (i.e. a first type container handling vehicle) featuring a first exemplary container lift device 504, and FIGS. 7-14 are detailed views of the container lift device 504. The container handling vehicle 501 is intended for a prior art storage system as shown in FIG. 1. Like the prior art vehicles, the container handling vehicle 501 comprises a vehicle body 501a and a first and a second set of wheels 501, 501c enabling the lateral movement of the container handling vehicle in the X direction and in the Y direction, respectively.

The container lift device 504 comprises a lifting frame 2′, wherein a vertical guiding pin 4′ is slidably connected at each of four frame corners 17 of the lifting frame 2′ by a bracket 18. A lower part of each guiding pin 4′ has a recess 6 or notch (i.e. a container support portion) comprising a container support surface 11. The container support surface 11 is provided on a lower part of the recess 6.

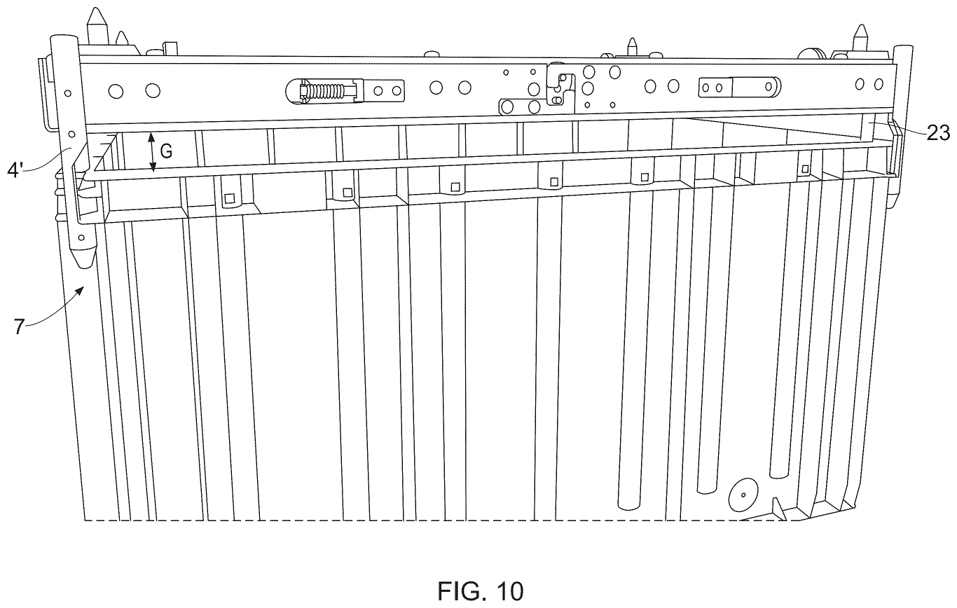

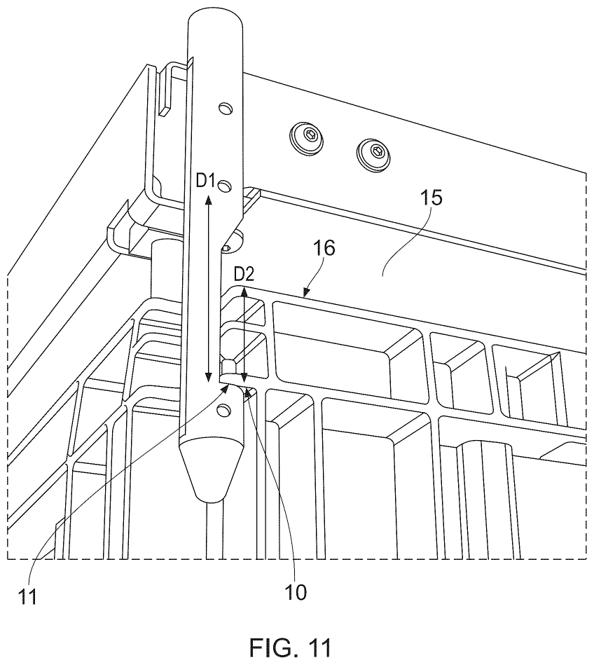

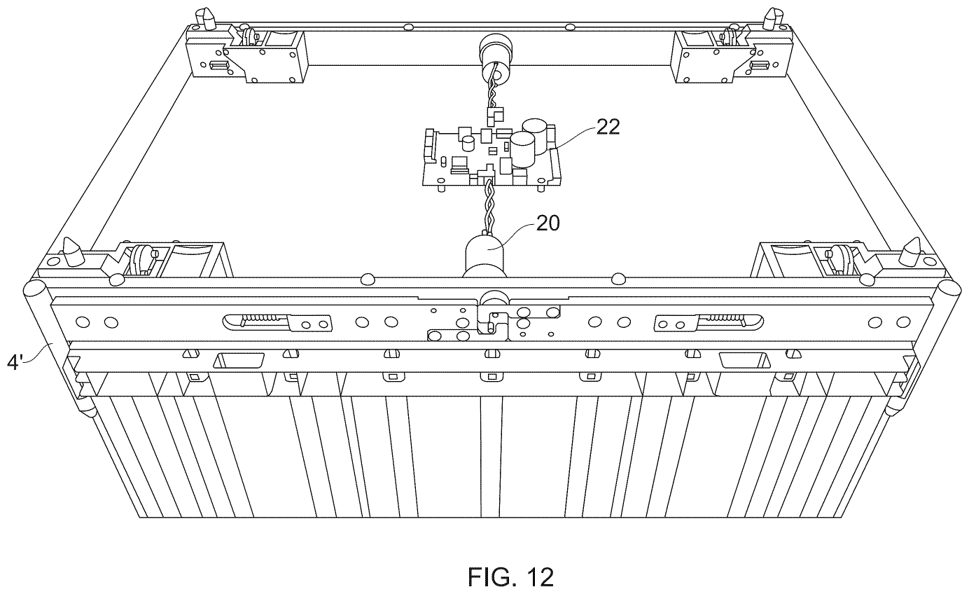

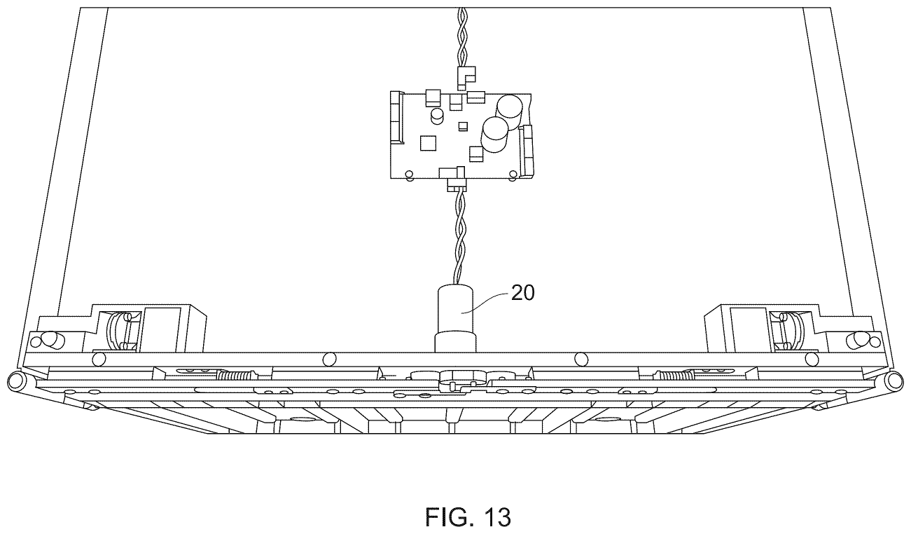

The recess 6 is moveable between a first position, see FIGS. 7-9, and a second position, see FIGS. 10-12, by sliding the corresponding guiding pin in a lateral direction. In the second position the recess 6 is displaced closer to a vertical centreline (C) of the lifting frame than in the first position. The brackets 18 of two opposite guiding pins 4′ are interconnected by a pivot assembly 19 arranged to laterally move the brackets 18 towards each other, such that the recesses 6 of two opposing guiding pins 4′ will move from the first position to the second position. The pivot assembly 19 is driven by an actuator 20, see FIGS. 12 and 13. The pivot assembly 19 comprises two actuator arms 24, each arm connected to an actuatable pivot 25 and a corresponding bracket 18, such that rotation of the pivot translates into lateral movement of the brackets in opposite directions.

A storage container suitable for releasable connection to the container lift device 504 is shown in FIG. 5. An outer periphery of the storage container 106 comprises a vertical guiding pin recess 7 at each of four container corners 12. During an initial interaction between the container lift device 504 and a storage container, the recesses 6 of the container lift device 504 are in the first position and the guiding pins 4′ can enter the corresponding guiding pin recess 7 of the storage container. To releasably connect the container lift device 504 to the storage container, the recesses 6 are moved to the second position. In the second position the recesses 6 have been displaced such that the container support surfaces 11 can support the storage container 106 via downwardly facing support surfaces 10 of the storage container.

The downwardly facing support surfaces 10 of the storage container 106 are arranged on a corresponding horizontal rib portion 9 at the periphery of the guiding pin recesses 7.

In the exemplary embodiment, the lifting frame 2′ comprises a lower bottom surface 15, and the upwardly facing support surfaces 11 are arranged at a level below the lower bottom surface 15 such that a horizontally extending gap G is formed between the lower bottom surface 15 and an upper rim 16 of the storage container 106 to which the lifting frame 2′ is connected, see FIGS. 8 and 10. The height of the gap G is preferably greater than 0.5 cm, more preferably greater than 1.0 cm, and may be between 0.5 and 20.5 cm. The presence of the gap may be advantageous in situations where goods extend more than 0.5 cm above the upper rim of the storage container and would otherwise prevent the lifting frame from landing properly upon the storage container during an initial interaction. The goods may be rigid goods like boxes that have become misloaded or misaligned within the storage container 106, or they may be clothing or the like that has expanded and which could obscure the upper rim 16 of the storage container 106 during lowering of the prior art lifting frame. To obtain a gap G, a first vertical distance D1 between the upwardly facing support surfaces 11 and the lower bottom surface 15 is greater than a second vertical distance D2 between the downwardly facing support surfaces 10 and an upper rim 16 of the storage container, see FIG. 11.

To raise or lower the lifting frame 2′ (and optionally a connected storage container 106), the lifting frame 2′ is suspended from a band drive assembly (not shown) by lifting bands 5. The lifting bands, preferably metal lifting bands, are arranged to transmit required electric power and/or control signals from a battery and/or control system, arranged in the vehicle body of the container handling vehicle, to a control module 22 and the actuator 20.

The lifting bands are also used to conduct electric power and signals to end switch modules 21 on the lifting frame 2′. The end switch modules 21 comprise spring-loaded pins 23 (see FIG. 21) for detecting when the lifting frame 2′ is in contact with a storage container 106.

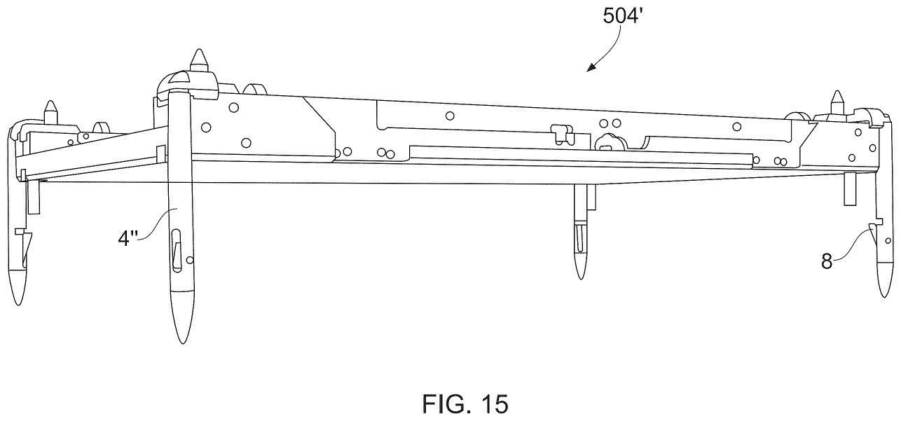

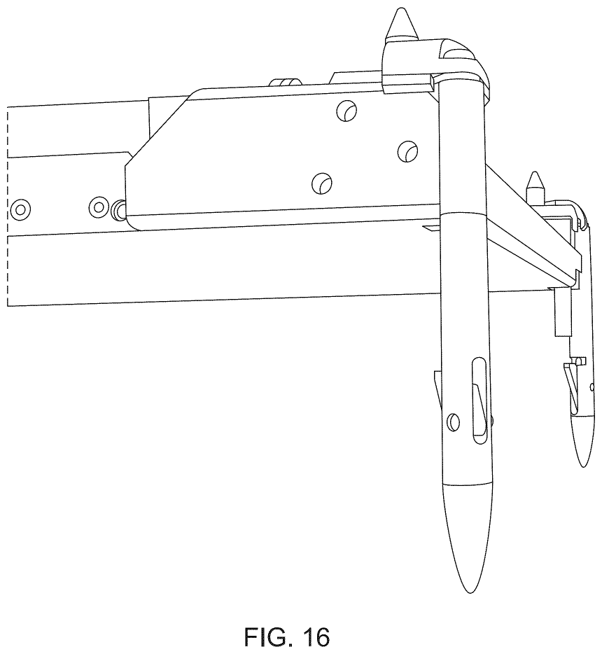

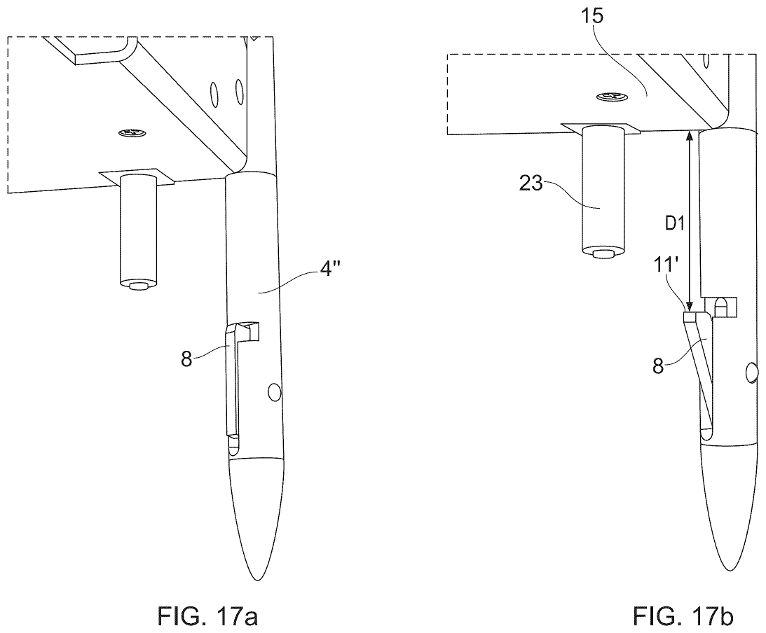

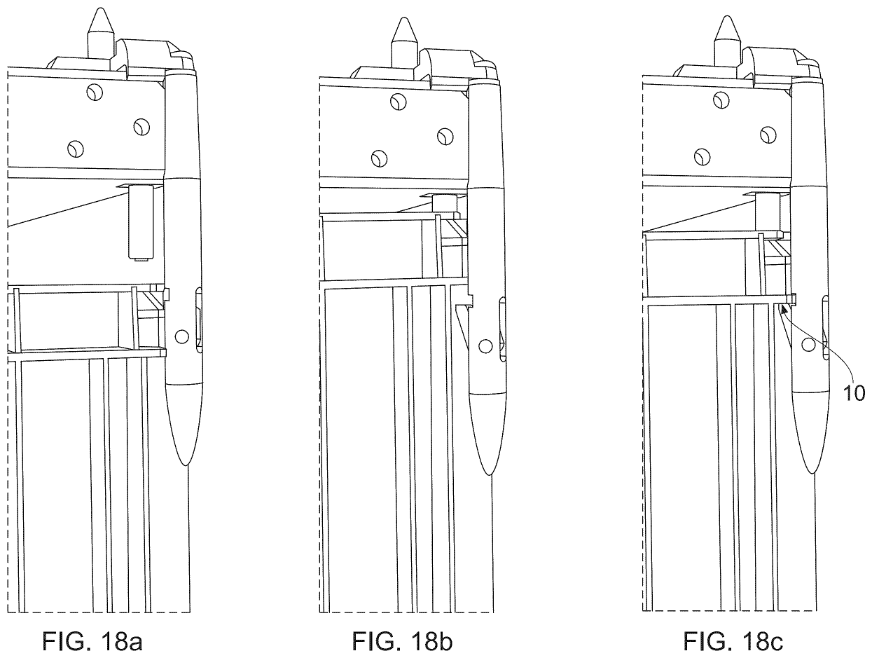

A second exemplary container lift device 504′ is shown in FIGS. 15-18. In the second exemplary embodiment, the container support portion of each guiding pin 4″ comprises a hook 8 having a container support surface 11′. The hooks 8 are configured to pivot between the first position and the second position. That is, in the second position the hooks 8 have been pivoted such that the container support surfaces 11′ face upwardly and are positioned below the downwardly facing support surfaces. During an initial interaction between the container lift device 504′ and a storage container 106, see e.g. FIGS. 17a and 18a, the hooks 8 of the container lift device 504′ are in the first position and the guiding pins 4″ can enter the corresponding guiding pin recess 7 of the storage container. To connect the container lift device 504′ to the storage container, the hooks are moved to the second position. In the second position the hooks 8 have been displaced such that the container support surfaces 11′ can support the storage container 106 via downwardly facing support surfaces 10 of the storage container.

In the second exemplary embodiment, the hooks 8 are biased, e.g. by a spring, towards the second position, and the hooks are displaced into the first position by the periphery of the storage container during initial interaction, such that the guiding pins 4″ may enter the guiding pin recesses 7, see FIG. 18a. When the hooks 8 have passed the upper periphery of the storage container, the hooks 8 will move into the second position. In further embodiments, the hooks 8 may be actuated between the first and second position by any suitable actuator assembly, such as a linear or rotating actuator in or at each guiding pin 4″.

In the exemplary embodiments disclosed above, the guiding pins 4′, 4″ have multiple functions by guiding the lifting frame relative to the upright members 102 defining the storage columns 105, ensuring a correct alignment of the lifting frame 2′ relative to a storage container during initial interaction and providing container support surfaces for connection to the storage container.

In the exemplary embodiments disclosed above, all four of the guiding pins 4′, 4″ have a container support portion. It is however contemplated alternative embodiments, wherein only two of the four guiding pins feature a container support portion. In such embodiments, the two guiding pins featuring a container support portion are preferably arranged at two frame corners being diagonally opposite each other relative to a vertical centreline (C) of the lifting frame.

In a storage system according to the invention, the storage system may comprise at least one first type of container handling vehicle (i.e. a container handling vehicle 501 having an exemplary container lift device 504) and a plurality of a second type of container handling vehicles (i.e. prior art container handling vehicles 201, 301, 401 as described in the background section). In such a storage system, the second type of container handling vehicles perform the main function of retrieving/delivering storage containers from/to the storage columns 105, as well as transporting the storage containers upon the rail system 108 of the storage system. The function of the first type of container handling vehicle 501 is to retrieve storage containers which the second type of storage containers are unable to retrieve due to e.g. improper loading as discussed above.

### LIST OF REFERENCE NUMBERS

1 Prior art automated storage and retrieval system
2 Prior art lifting frame for second type of container handling vehicles
2′ Lifting frame
3 Container connector
4 Prior art guiding pin, second type of guiding pin
4′ Guiding pin
5 Lifting bands
6 Recess, notch, container support portion
7 Guiding pin recess
8 Hook, container support portion
9 Horizontal rib portion
10 Downwardly facing support surface on storage container
11, 11′ Container support surface
12 Container corner
13 Connecting recess in upper rim of storage container
14 Sidewall of storage container
15 Lower bottom surface of lifting frame
16 Upper rim of storage container
17 Frame corner
18 Bracket
19 Actuator assembly, pivot assembly
20 Actuator
21 End switch module
22 Control module
23 Spring-loaded pin
24 Actuator arm
25 Pivot
100 Framework structure
102 Upright members of framework structure
103 Horizontal members of framework structure
104 Storage grid
105 Storage column
106 Storage container
106′ Particular position of storage container
107 Stack
108 Rail system
110 Parallel rails in first direction (X)
110a First rail in first direction (X)
110b Second rail in first direction (X)
111 Parallel rail in second direction (Y)
111a First rail of second direction (Y)
111b Second rail of second direction (Y)
112 Access opening
119 First port column
120 Second port column
201 Prior art container handling vehicle
201a Vehicle body of the container handling vehicle 201
201b Drive means/wheel arrangement, first direction (X)
201c Drive means/wheel arrangement, second direction (Y)
301 Prior art cantilever container handling vehicle
301a Vehicle body of the container handling vehicle 301
301b Drive means in first direction (X)
301c Drive means in second direction (Y)
401 Prior art container handling vehicle
401a Vehicle body of the container handling vehicle 401
401b Drive means in first direction (X)
401c Drive means in second direction (Y)
Y Second direction
Z Third direction

1. A storage system comprising a framework structure, at least one container lift device, and a plurality of storage containers,
wherein the framework structure comprises multiple storage columns, in which the storage containers are stored on top of one another in vertical stacks, and the container lift device comprises a lifting frame for releasable connection to one of the storage containers when the lifting frame is lowered into one of the storage columns to retrieve said storage container,
wherein an outer periphery of each storage container comprises a vertical guiding pin recess at each of four container corners,
wherein a vertical guiding pin is provided at each of four frame corners of the lifting frame, a lower part of at least two of the guiding pins have a container support portion comprising a container support surface, and
wherein the container support portion is moveable in a lateral direction between a first position, in which the guiding pins can enter the corresponding guiding pin recess of a storage container, and a second position, in which the container support portion is displaced closer to a vertical centreline of the lifting frame than in the first position such that the container support surfaces are positioned to support the storage container via downwardly facing support surfaces of the storage container.

2. The storage system according to claim 1, wherein the guiding pins are arranged to guide the lifting frame relative to upright members defining the storage columns.

3. The storage system according to claim 1, wherein each of the downwardly facing support surfaces of the storage container is arranged on a corresponding horizontal rib portion at the periphery of the guiding pin recesses.

4. The storage system according to claim 3, wherein each of the container support portions is configured to extend under the corresponding horizontal rib portion of a storage container when in the second position and the guiding pins are arranged in the guiding pin recesses of the storage container.

5. The storage system according to claim 4, wherein each of the container support portions is removed from the corresponding horizontal rib portion when in the first position, such that the storage container is released from the lifting frame.

6. The storage system according to claim 1, wherein the lifting frame comprises a lower bottom surface, and the upwardly facing support surfaces are arranged at a level below the lower bottom surface such that a horizontally extending gap is formed between the lower bottom surface and an upper rim of a storage container to which the lifting frame is connected, the height of the gap being between 0.5 and 20.5 cm.

7. The storage system according to claim 6, wherein the container support portions extend to a level below the bottom surface, such that a first vertical distance between the upwardly facing support surfaces and the lower bottom surface is greater than a second vertical distance between the downwardly facing support surfaces and an upper rim of the storage container, such that the gap is obtained.

8. The storage system according to claim 1, wherein the lifting frame comprises an actuator assembly for moving the container support portions between the first position and the second position, the actuator assembly comprising an electric motor or linear actuator.

9. The storage system according to claim 1, wherein the container support portion comprises a recess in the guiding pin, and a lower part of the recess provides the upwardly facing support surface.

10. The storage system according to claim 9, wherein the recess has a height of more than a vertical distance between the downwardly facing support surfaces of the storage container and an upper rim of the storage container.

11. The storage system according to claim 9, wherein the container support portions are moveable from the first position to the second position by moving the guiding pins closer to the vertical centreline of the lifting frame.

12. The storage system according to claim 1, wherein the guiding pins are slidably arranged on the lifting frame, such that the guiding pins are moveable in a horizontal direction relative to the vertical centreline of the lifting frame.

13. The storage system according to claim 1, wherein the container support portion comprises a hook, the hook comprising the container support surface and is configured to pivot between the first position and the second position.

14. The storage system according to claim 1, wherein each of the container support portions is biased towards the second position.

15. The storage system according to claim 1, wherein a rail system is arranged at a top level of the framework structure, and the container lift device is part of a first type of container handling vehicle operated on the rail system for retrieving storage containers from, and storing storage containers in, the storage columns, and for transporting the storage containers horizontally across the rail system.

16. The storage system according to claim 15, comprising a plurality of a second type of container handling vehicles operated on the rail system for retrieving storage containers from, and storing storage containers in, the storage columns, and for transporting the storage containers horizontally across the rail system, each of the second type of container handling vehicles featuring a container lift device comprising a lifting frame for releasable connection to one of the storage containers when the lifting frame is lowered into one of the storage columns to retrieve said storage container,
wherein the lifting frame comprises a vertical guiding pin at each of four frame corners of the lifting frame and a plurality of container connectors for engagement with corresponding connecting recesses at an upper rim of the storage container.

17. The lifting frame for the storage system according to claim 1,
wherein a vertical guiding pin is connected at each of four frame corners of the lifting frame and at least two of the vertical guiding pins are slidably connected at a corresponding frame corner, a lower part of each of the slidably connected guiding pins having a container support portion comprising a container support surface,
wherein the container support portion is moveable between a first position and a second position by sliding the corresponding guiding pin in a horizontal direction, and in the second position the container support portion is displaced closer to a vertical centreline of the lifting frame than in the first position.

18. The lifting frame according to claim 17, wherein each of the guiding pins is slidably connected at a corresponding frame corner by a bracket, the brackets of two opposite guiding pins being interconnected by an actuator assembly arranged to laterally move the brackets and the corresponding guiding pins toward each other, such that the container support portions of two opposite guiding pins will move from the first position to the second position.

19. A container handling vehicle for a storage system comprising a framework structure, at least one container lift device, and a plurality of storage containers,
wherein the framework structure comprises multiple storage columns, in which the storage containers are stored on top of one another in vertical stacks, and the container lift device comprises a lifting frame for releasable connection to one of the storage containers when the lifting frame is lowered into one of the storage columns to retrieve said storage container,
wherein an outer periphery of each storage container comprises a vertical guiding pin recess at each of four container corners,
wherein a vertical guiding pin is provided at each of four frame corners of the lifting frame, a lower part of at least two of the guiding pins have a container support portion comprising a container support surface, and
wherein the container support portion is moveable in a lateral direction between a first position, in which the guiding pins can enter the corresponding guiding pin recess of a storage container, and a second position, in which the container support portion is displaced closer to a vertical centreline of the lifting frame than in the first position such that the container support surfaces are positioned to support the storage container via downwardly facing support surfaces of the storage container,
the container handling vehicle comprising a container lift device having a lifting frame for releasable connection to a storage container, a vehicle body and a first set of wheels and a second set of wheels enabling horizontal movement of the container handling vehicle in two perpendicular directions upon the rail system,
wherein a vertical guiding pin is provided at each of four frame corners of the lifting frame, a lower part of at least two of the guiding pins having a container support portion comprising a container support surface, and
wherein the container support portion is moveable in a horizontal direction between a first position and a second position, in the second position the container support portion is displaced closer to a vertical centreline of the lifting frame than in the first position.

20. The container handling vehicle according to claim 19, comprising a lifting frame,
wherein a vertical guiding pin is connected at each of four frame corners of the lifting frame and at least two of the vertical guiding pins are slidably connected at a corresponding frame corner, a lower part of each of the slidably connected guiding pins having a container support portion comprising a container support surface,
wherein the container support portion is moveable between a first position and a second position by sliding the corresponding guiding pin in a horizontal direction, and in the second position the container support portion is displaced closer to a vertical centreline of the lifting frame than in the first position.

21. A method of retrieving a storage container from a storage column in a storage system comprising a framework structure, at least one container lift device, and a plurality of storage containers,
wherein the framework structure comprises multiple storage columns, in which the storage containers are stored on top of one another in vertical stacks, and the container lift device comprises a lifting frame for releasable connection to one of the storage containers when the lifting frame is lowered into one of the storage columns to retrieve said storage container,
wherein an outer periphery of each storage container comprises a vertical guiding pin recess at each of four container corners,
wherein a vertical guiding pin is provided at each of four frame corners of the lifting frame, a lower part of at least two of the guiding pins have a container support portion comprising a container support surface,
wherein the container support portion is moveable in a lateral direction between a first position, in which the guiding pins can enter the corresponding guiding pin recess of a storage container, and a second position, in which the container support portion is displaced closer to a vertical centreline of the lifting frame than in the first position such that the container support surfaces are positioned to support the storage container via downwardly facing support surfaces of the storage container, and
wherein a rail system is arranged at a top level of the framework structure, and the container lift device is part of a first type of container handling vehicle operated on the rail system for retrieving storage containers from, and storing storage containers in, the storage columns, and for transporting the storage containers horizontally across the rail system.
the storage system comprising a plurality of a second type of container handling vehicles operated on the rail system for retrieving storage containers from, and storing storage containers in, the storage columns, and for transporting the storage containers horizontally across the rail system, each of the second type of container handling vehicles featuring a container lift device comprising a lifting frame for releasable connection to one of the storage containers when the lifting frame is lowered into one of the storage columns to retrieve said storage container,
wherein the lifting frame comprises a vertical guiding pin at each of four frame corners of the lifting frame and a plurality of container connectors for engagement with corresponding connecting recesses at an upper rim of the storage container,
the method comprising:
moving a second type container handling vehicle to retrieve the storage container from the storage column;
lowering the lifting frame of the second type container handling vehicle into the storage column to retrieve the storage container;
detecting an error in the connection of the lifting frame to the storage container;
raising the lifting frame and moving the second type of container handling vehicle away from the storage column;
moving a first type container handling vehicle to the storage column; and
lowering the lifting frame of the first type container handling vehicle into the storage column and retrieving the storage container.
